(19) United States
(12) Patent Application Publication
(10) Pub. No.: US 2010/0121574 A1
(43) Pub. Date: May 13, 2010

(54) METHOD FOR COLLISION AVOIDANCE OF UNMANNED AERIAL VEHICLE WITH OTHER AIRCRAFT

(75) Inventors: Kartik B. Ariyur, Minneapolis, MN (US); Michael R. Elgersma, Plymouth, MN (US)

Correspondence Address: HONEYWELL/FOGG;Patent Services, 101 Columbia Road, P.O Box 2245, Morristown, NJ, 07962-2245, US

(73) Assignee: Honeywell International Inc., Morristown, NJ (US)

(21) Appl. No.: 11/470,099

(22) Filed: Sep. 5, 2006

(51) Int. Cl. G08G 5/04

(52) U.S. Cl. 701/301

(57) ABSTRACT

A method for collision avoidance of an unmanned aerial vehicle (UAV) with other aircraft such as manned aircraft or another UAV is provided. The method comprises detecting an aircraft approaching a flight path of an unmanned aerial vehicle, and estimating a position, range, and velocity of the aircraft. An estimated path of the aircraft is determined from the position, range, and velocity. A new flight path is then calculated for the unmanned aerial vehicle to a waypoint to avoid the estimated path of the aircraft.

### BACKGROUND

Unmanned aerial vehicles (UAVs) are remotely piloted or self-piloted aircraft that can carry cameras, sensors, communications equipment, or other payloads. For many years, UAVs have been used in a reconnaissance and intelligence-gathering role. More recently, UAVs have been developed for the purpose of surveillance and target tracking, in either military or civilian environments.

In order to provide for safe operation of UAVs in shared airspace, significant safety issues related to path planning need to be addressed. There is a need to keep a UAV at a safe distance both from manned aircraft and from other UAVs, especially if the UAV flights are not coordinated by a single controller. Hence, guaranteed collision avoidance is necessary for widespread use of UAVs in military and civilian applications.

The current state of the art provides for maintaining conservative separations between flying vehicles. There is no method available to handle uncoordinated autonomous flying vehicles and/or manned flying vehicles. While Laplacian path planning has been researched for several years, no practical solutions have been developed for collision avoidance with moving objects.

### SUMMARY

The present invention is related to a method for collision avoidance of an unmanned aerial vehicle (UAV) with other aircraft, such as manned aircraft or another UAV. The method comprises detecting an aircraft approaching a flight path of an unmanned aerial vehicle, and estimating a position, range, and velocity of the aircraft. An estimated path of the aircraft is determined from the position, range, and velocity. A new flight path is then calculated for the unmanned aerial vehicle to a waypoint to avoid the estimated path of the aircraft.

### BRIEF DESCRIPTION OF THE DRAWINGS

Features of the present invention will become apparent to those skilled in the art from the following description with reference to the drawings. Understanding that the drawings depict only typical embodiments of the invention and are not therefore to be considered limiting in scope, the invention will be described with additional specificity and detail through the use of the accompanying drawings, in which:

FIGS. 1A and 1B are schematic diagrams illustrating the operation of a method of the invention in an unmanned aerial vehicle (UAV) to avoid collision with another aircraft; and

FIG. 2 is a processing flow diagram for a method of the invention used in a UAV to avoid collision with another aircraft.

### DETAILED DESCRIPTION

The present invention relates to a method for collision avoidance of an unmanned aerial vehicle (UAV) with another aircraft, either manned or unmanned. The method provides for autonomous path replanning for a UAV upon sighting a manned aircraft or other UAVs. As a result, safety guarantees for manned aircraft or other UAVs are also provided.

In the present method, from measurements and estimates of position, range, and velocity of a detected aircraft, a UAV uses a simple or model-based prediction of the path of the detected aircraft to assign potentials in space and time. For example, the UAV can be configured to mark a virtual cylinder in space as a virtual obstacle, which represents the predicted path of the detected aircraft, by using a model-based prediction of the aircraft. The UAV can then recompute its own path to a next waypoint using a partial differential equation (PDE) solution to avoid the virtual obstacle. A “waypoint” can be a destination, a location of a course change, or a point of reference useful for navigation.

Suitable PDE solutions can include those derived from Laplace's equation, the wave equation, and the like. The existence of a solution to these equations guarantees collision avoidance in a dynamic obstacle field. By using the Laplacian or wave equation, a potential function with a global minimum and no local extrema can be obtained. The gradient of the potential function is used to determine a safe path through an obstacle field.

In addition, maximum safe speeds in UAV airspace are provided along with a minimum miss distance. These safety guarantees are dependent upon UAV and manned vehicle speed and acceleration limits, and UAV sensor range and accuracy. The present method permits dynamically setting separations depending upon the vehicles in the airspace without extensive parameter changes. The available error bounds for numerical PDE solutions permit deriving guarantees based on vehicle and sensor properties.

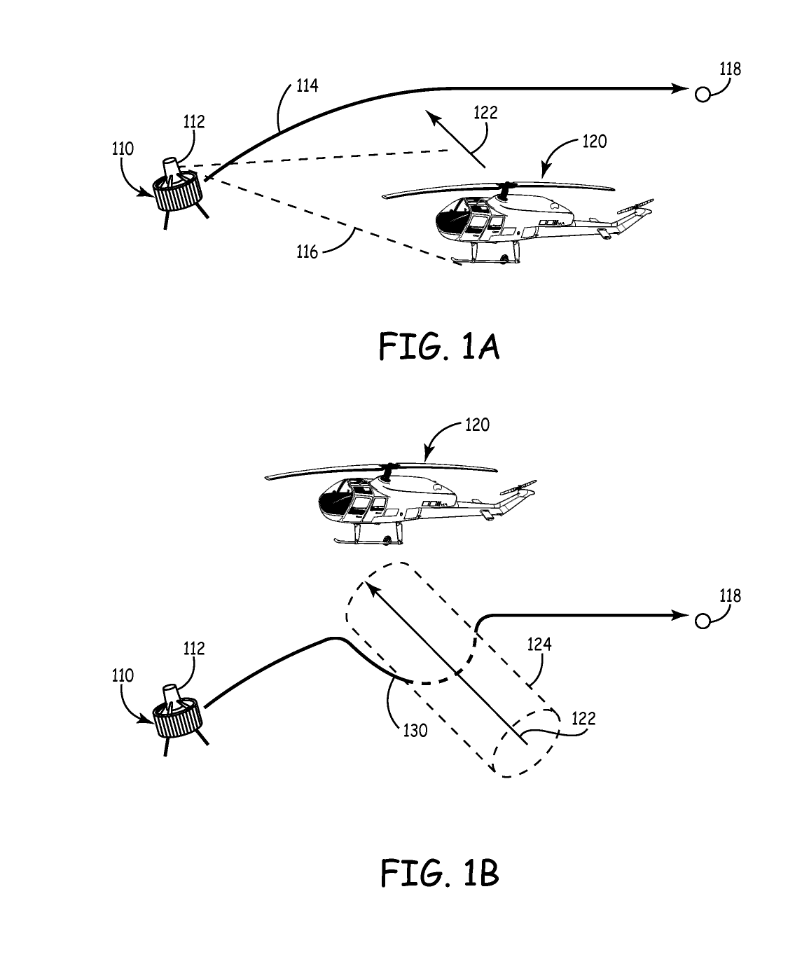

FIG. 1A is a schematic diagram depicting the operation of the method of the invention, according to one embodiment, in a UAV 110 having one or more sensors 112. The UAV 110 can be a hover-capable aerial vehicle or a fixed-wing aerial vehicle. A variety of one or more sensors can be used in the UAV, such as an optical sensor (e.g., a camera for optical/visual detection), a radar sensor (e.g., Doppler radar for velocity measurements), laser detection and ranging (LADAR) or acoustic sensors (for distance measurements), or combinations thereof. The sensors provide a means for detecting an aircraft approaching the path of the UAV.

As shown in FIG. 1A, UAV 110 is traveling along a path 114 toward a next waypoint 118. An aircraft 120 that is approaching path 114 of UAV 110 is detected by sensors 112 when aircraft 120 comes with a field-of-view (FOV) 116 of sensors 112. The position, range, and velocity of aircraft 120 are measured through inputs from sensors 112 to determine an estimated path 122 of aircraft 120. The path 122 is considered to be a fixed obstacle that UAV 110 will have to go around, if path 122 intersects with the original flight path of the UAV.

As illustrated in FIG. 1B, a virtual shape 124 corresponding to the fixed obstacle is marked in space around path 122 by using a model-based prediction of aircraft 120. The fixed obstacle can be considered as a cylinder, for example, or other extended virtual solid around path 122 of aircraft 120. A new path 130 is computed for the UAV to waypoint 118 to avoid the obstacle and thus path 122 of aircraft 120. The new path 130 for the UAV goes entirely around path 122 (following the boundary of virtual shape 124), and is shown going underneath path 122. It should be understood, however, that a variety of different paths can be computed to avoid collision of the UAV with the approaching aircraft.

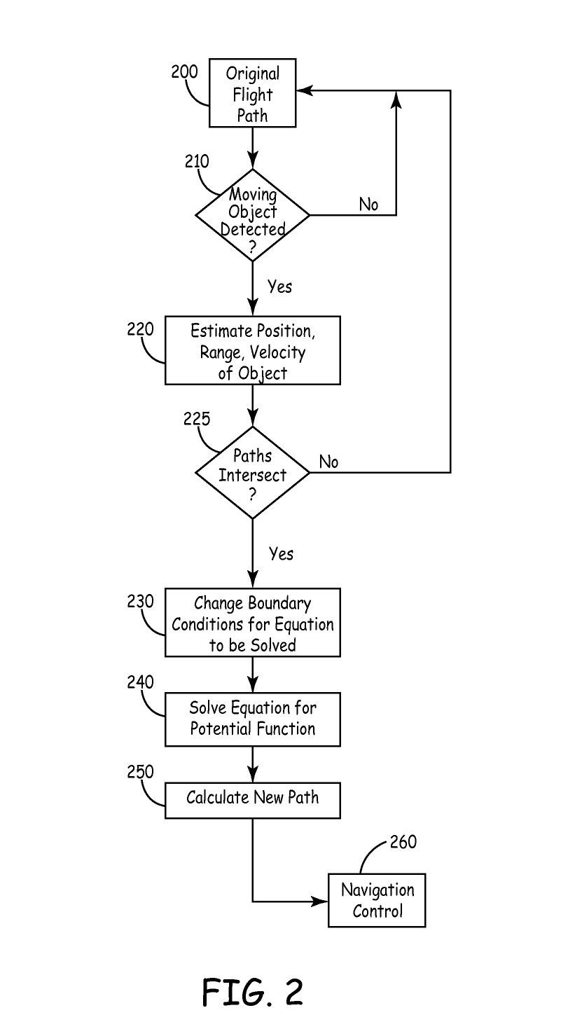

FIG. 2 is a processing flow diagram for the method of the invention used in a UAV to avoid collision with another aircraft. While the UAV is traveling along an original flight path (block 200) to a waypoint, a determination is made at 210 whether a moving object such as another aircraft has been detected by the sensors on the UAV. If not, then the original flight path is continued. If a moving object is detected, then the position, range, and velocity of the object are estimated at 220 to determine an estimated path of the aircraft. A determination is then made at 225 whether the estimated path of the aircraft will intersect with the original flight path of the UAV within predetermined bounds. If not, then the original flight path of the UAV is continued. If the estimated path of the aircraft will intersect with the original flight path of the UAV, then the boundary conditions for the equation to be solved (Laplacian, wave, etc.) are changed at 230. The equation is then solved for the potential function at 240 using the new boundary conditions. A new path is then calculated for the UAV to the next waypoint at 250. This can be done by using the gradient of the potential function to determine the new path. Information about the new path is then sent to a navigation control system 260 of the UAV for implementation.

The present method can employ standard multigrid algorithms for solving Laplace's equation or the wave equation, using either sequential or parallel processing. For example, the use of Laplacian potential path planning algorithms provides mathematical guarantees of collision avoidance/safety for aircraft. The Laplacian potential path planning algorithms produce smooth, usually navigable, paths that can be easily updated as obstacles or other moving vehicles enter and leave from the region of interest of the UVA. The use of fast computers and efficient algorithms permit solving Laplace's equation or the wave equation in real-time in 3-dimensional space, which is the domain over which Laplace's equation or the wave equation is solved. This permits application of such algorithms to the present collision avoidance method.

The solution to Laplace's equation or the wave equation is a harmonic function, which has the property of no maxima or minima except on the boundaries. This allows the UAV to follow the gradient of the harmonic function obtained by solving the equation. Since the harmonic function has a unique global minimum that is set as a destination, if there exists a new path to avoid collision, the present method will find such a path.

It should be noted that for a fixed wing UAV, a smooth path with more arc or curve is required in order to avoid the path of another aircraft. Such a requirement needs to be taken into account prior to computing a new path for the UAV.

Alternatively, Laplacian path replanning with respect to moving obstacles can be accomplished through a homotopy between the numerical Laplace's equation and the numerical wave equation or other appropriate equation for a potential. The term “homotopy” refers to the use of homotopic continuation methods to obtain a solution of the wave equation by solving a ‘nearby’ Laplace equation, and deforming this solution (numerically) to obtain the solution of the wave equation. This should work well (with safety guarantees) when there are not too many moving vehicles to avoid, and the rate of change of boundary conditions due to moving obstacles is small in some sense. For example, if the moving obstacles are moving well away from the UAV or manned airplane, it does not matter even if the obstacles are moving fast as they do not affect the local potentials very much.

### Laplace's Equation

The present method can use Laplace's equation for airborne collision avoidance of a UAV with another aircraft, either manned or unmanned. In three dimensions, the problem is to find twice-differentiable real-valued functions φ of real variables x, y, and z such that:

$$\frac{{\partial }^{2} ϕ}{\partial {x}^{2}} + \frac{{\partial }^{2} ϕ}{\partial {y}^{2}} + \frac{{\partial }^{2} ϕ}{\partial {z}^{2}} = 0$$

This is often written as:

V̅²φ=0 or divgradφ=0,

where div is the divergence and grad is the gradient, or

Δφ=0

where Δ is the Laplace operator.

The present technique constructs paths, r(t), through a three-dimensional (3-D) domain by assigning a potential value of v(r)=0 for r on any boundaries or obstacle, and a potential of v(r)=1 for r on the goal region. Then, Laplace's equation is solved in the interior of the 3-D region, guaranteeing no local minima in the interior of the domain, leaving a global maximum of v(r)=1 for r on the goal region, and global minima of v(r)=0 for r on any boundaries or obstacle. A path from any initial point, r(0), to the goal, is constructed by following the gradient of the potential, v.

A physical analogy for paths obtained by Laplace's equation is to apply a voltage of 0 to all boundary and obstacle locations, a voltage of 1 to a goal region, fill an interior region with a conductor, then electrons will follow paths from anywhere in the interior to the goal region. Laplace's equation sets the divergence of a potential to zero in the interior of a domain. Solutions of Laplace's equation are harmonic functions, which have no local minima in the interior of their domain.

Numerical solutions of Laplace's equation are obtained by gridding the domain, then iteratively setting the potential at each interior point, equal to the average of its nearest neighbors. By varying the grid size (halving or doubling cell length at each step) from the crudest that stills leaves paths between obstacles, to the finest that is required for smooth paths, the iteration can be made to converge in a time proportional to the number, N, of cells in the finest grid. The solution on crude grids is used to initialize the solution on finer grids.

Textbook convergence proofs for empty domains, give the total number of computations to be c*N, where N is the number of cells in the finest grid, and c≈5 is some small number of iterations at each grid size. That convergence speed relies on being able to set the crudest grid cell size equal to the entire domain for the crudest solution. However, in a domain with obstacles, the number of needed iterations is given by c*(path length)/(path width), since path width between obstacles limits the largest cell size of the crudest grid that still preserves the topology of the computed paths. With the largest grid cell size set equal to the path width, the number of grid cells along the path equals (path length)/(path width). The iterative process of setting a cell's potential equal to the average of its neighbor's potentials, propagates a nonzero solution value a distance of one more grid cells along the path, with each iteration. So it takes (path length)/(path width) iterations for a nonzero solution to propagate along the entire path length, when the crudest grid cell size is equal to path width. After c*(path length)/(path width) iterations, with c≈5, the iteration converges on the crudest grid. Using this same number of iterations on each finer grid size, results in the bulk of the work being done by the c*(path length)/(path width) iterations on the finest grid size, for a total number of operations of approximately c*(path length)/(path width)*N, where N is the total number of cells in the finest grid.

### The Wave Equation

The present method can also use the wave equation for airborne collision avoidance of a UAV with another aircraft, either manned or unmanned. The wave equation can provide for collision avoidance in the presence of dynamic obstacles and perhaps even dynamic boundary conditions, allowing for a less conservative solution.

In its simplest form, the wave equation refers to a scalar quantity u that satisfies:

$$\frac{{\partial }^{2} u}{\partial {t}^{2}} = {c}^{2} Δ u ,$$

where c is a fixed constant equal to the propagation speed of the wave and where:

Δ= V̅² is the Laplacian.

Using the wave equation to avoid dynamic obstacles allows for the present method to avoid putting virtual shapes such as cylinders around moving vehicles. Objects are considered as moving potential surfaces, which are used to solve the wave equation. If there exists a collision-free or avoidance path for the UAV in the airspace, the solution to the wave equation will find it. The number of iterations used will depend upon both the changes to the boundary conditions and the complexity of the obstacle field (path length/path width).

The present method can use a three-dimensional wave equation when static and moving obstacles are sufficiently far away as to allow spherically symmetric boundary conditions. This equation can be written as:

$${u}_{tt} - {c}^{2} ( {u}_{rr} + \frac{2}{r} {u}_{r} ) = 0$$

This equation may be rewritten as:

(ru)ᵤ−c²(ru)ᵣᵣ=0

where the quantity ru satisfies the one-dimensional wave equation. Therefore there are solutions in the form:

$$u ( t , r ) = \frac{1}{r} F ( r - ct ) + \frac{1}{r} G ( r + ct ) ,$$

where F and G are arbitrary functions. Each term may be interpreted as a spherical wave that expands or contracts with velocity c.

In order to increase the speed of operation, the present method can be implemented through parallelization. This allows multiple software programs to be run on one or more processors at the same time. There are many conventional parallelization methods for the Laplacian, and many of them can be generalized to the wave equation. Since wave velocity propagates at finite velocity, changes in one region do not affect the potential in other regions until the passage of the relevant time interval (distance/speed). Hence, calculations in regions without mutual influence can be separately done, and solutions can be superposed as the equation is linear. The effect on potential of changes in different boundary conditions can be propagated through the solution separately and added to the overall solution to update it.

Instructions for carrying out the various process tasks, calculations, and generation of signals and other data used in the operation of the systems and methods of the invention can be implemented in software, firmware, or other computer readable instructions. These instructions are typically stored on any appropriate computer readable media used for storage of computer readable instructions or data structures. Such computer readable media can be any available media that can be accessed by a general purpose or special purpose computer or processor, or any programmable logic device.

Suitable computer readable media may comprise, for example, non-volatile memory devices including semiconductor memory devices such as EPROM, EEPROM, or flash memory devices; magnetic disks such as internal hard disks or removable disks; magneto-optical disks; CDs, DVDs, or other optical storage disks; nonvolatile ROM, RAM, and other like media; or any other media that can be used to carry or store desired program code means in the form of computer executable instructions or data structures. Any of the foregoing may be supplemented by, or incorporated in, specially-designed application-specific integrated circuits (ASICs). When information is transferred or provided over a network or another communications connection (either hardwired, wireless, or a combination of hardwired or wireless) to a computer, the computer properly views the connection as a computer readable medium. Thus, any such connection is properly termed a computer readable medium. Combinations of the above are also included within the scope of computer readable media.

Although not required, the method of the invention will be described in the general context of computer readable instructions, such as program modules, being executed by a processor. Generally, program modules include routines, programs, objects, data components, data structures, algorithms, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

1. A method for collision avoidance of an unmanned aerial vehicle with other aircraft, the method comprising:
detecting an aircraft approaching a flight path of an unmanned aerial vehicle;
estimating a position, distance, and velocity of the aircraft;
determining an estimated path of the aircraft from the position, distance, and velocity; and
calculating a new flight path for the unmanned aerial vehicle to a waypoint to avoid the estimated path of the aircraft, wherein calculating the new flight path comprises:
solving a partial differential equation for a potential function defined by boundary conditions of a three-dimensional domain, wherein substantially no local minima exist along a boundary of the domain as substantially all boundary points of the domain have a potential value of zero; and
constructing the new flight path by following a gradient of the potential function.

2. The method of claim 1, wherein the unmanned aerial vehicle comprises a hover-capable aerial vehicle or a fixed-wing aerial vehicle.

3. The method of claim 1, wherein the aircraft comprises a manned aircraft or another unmanned aerial vehicle.

4. The method of claim 1, wherein the aircraft is detected by one or more sensors on the unmanned aerial vehicle.

5. The method of claim 4, wherein the one or more sensors comprise at least one of an optical sensor, a radar sensor, an acoustic sensor, a laser detection and ranging sensor, or combinations thereof.

6. The method of claim 1, wherein the position, distance, and velocity of the aircraft are estimated from measurements obtained by one or more sensors comprising a Doppler radar for velocity measurements, or a laser detection and ranging sensor for distance measurements.

7. The method of claim 6, wherein the potential comprises a Laplacian potential or a wave potential.

8. The method of claim 7, further comprising changing the boundary conditions for the partial differential equation prior to solving the equation.

9. The method of claim 7, further comprising marking a virtual shape in space as an obstacle that surrounds the estimated path by using a model-based prediction of the aircraft.

10. The method of claim 7, wherein solving the equation comprises considering the aircraft as a moving potential surface.

11. (canceled)

12. The method of claim 7, wherein the potential function has a global minimum and no local extrema.

13-20. (canceled)

21. A computer program product, comprising:
a computer readable medium having instructions stored thereon for a method for collision avoidance of an unmanned aerial vehicle with other aircraft, the method comprising:
estimating a position, distance, and velocity of a detected aircraft approaching a flight path of the unmanned aerial vehicle;
determining an estimated path of the aircraft from the position, distance, and velocity; and
calculating a new flight path for the unmanned aerial vehicle to a waypoint to avoid the estimated path of the aircraft, wherein calculating the new flight path comprises:
solving a partial differential equation for a potential function defined by boundary conditions of a three-dimensional domain, wherein substantially no local minima exist along a boundary of the domain as substantially all boundary points of the domain have a potential value of zero; and
constructing the new flight path by following a gradient of the potential function.

22. The computer program product of claim 21, wherein the potential comprises a Laplacian potential or a wave potential.

23. The computer program product of claim 21, wherein the instructions further comprise changing the boundary conditions for the partial differential equation prior to solving the equation.

24. The computer program product of claim 21, wherein the instructions further comprise marking a virtual shape in space as an obstacle that surrounds the estimated path by using a model-based prediction of the aircraft.

25-28. (canceled)

29. (canceled)

30. A system for collision avoidance of an unmanned aerial vehicle, the system comprising:
one or more sensors on the unmanned aerial vehicle configured to detect aircraft approaching a flight path of the unmanned aerial vehicle; and
a processor onboard the unmanned aerial vehicle, the processor configured to execute instructions stored on a computer readable medium for a method comprising:
estimating a position, distance, and velocity of a detected aircraft;
determining an estimated path of the aircraft from the position, distance, and velocity; and
calculating a new flight path for the unmanned aerial vehicle to a waypoint to avoid the estimated path of the aircraft, wherein calculating the new flight path comprises:
solving a partial differential equation for a potential function defined by boundary conditions of a three-dimensional domain, wherein substantially no local minima exist along a boundary of the domain as substantially all boundary points of the domain have a potential value of zero; and
constructing the new flight path by following a gradient of the potential function.
